(19) United States
(12) Patent Application Publication
(10) Pub. No.: US 2016/0161969 A1
(43) Pub. Date: Jun. 9, 2016

(54) SEMICONDUCTOR DEVICE

(71) Applicant: SK hynix Inc., Gyeonggi-do (KR)

(72) Inventor: Tae-Heui KWON, Gyeonggi-do (KR)

(21) Appl. No.: 14/698,438

(22) Filed: Apr. 28, 2015

(30) Foreign Application Priority Data
Dec. 9, 2014 (KR) 10-2014-0175922

(51) Int. Cl. G05F 3/02

(52) U.S. Cl. CPC G05F 3/02

(57) ABSTRACT

A semiconductor device may include: a first reference voltage generation unit: suitable for outputting an external voltage as a first reference voltage and clamping the first reference voltage based on a preset voltage in a positive direction from a ground voltage; a first internal voltage generation unit suitable for receiving the external voltage to drive an internal voltage terminal with a drivability corresponding to the first reference voltage; and a second internal voltage generation unit suitable for receiving the external voltage to drive the internal voltage terminal based on a second reference voltage greater than the preset voltage in the positive direction from the ground voltage.

### CROSS-REFERENCE TO RELATED APPLICATIONS

The present application claims priority of Korean Patent Application No. 10-2014-0175922 filed on Dec. 9, 2014, which is incorporated herein by reference in its entirety.

### BACKGROUND

1. Field

Exemplary embodiments of the present invention relate to a semiconductor design technology and, more particular, to a power-up operation of a semiconductor device.

2. Description of the Related Art

Semiconductor devices include power-up signal generation circuits to guarantee stable operation of internal circuits. The power-up signal generation circuit activates a power-up signal when an external voltage reaches a target voltage (i.e. voltage evel), for stable operation of the internal circuits.

### SUMMARY

Various embodiments are directed to a semiconductor device capable of minimizing the magnitude of peak current during a power-up operation.

In an embodiment, a semiconductor device may include: a first reference voltage generation unit suitable for outputting an external voltage as a first reference voltage and damping the first reference voltage based on a preset voltage in a positive direction from a ground voltage level; a first internal voltage generation unit suitable for receiving the external voltage to drive an internal voltage terminal with a drivability corresponding to the level of the first reference voltage; and a second internal voltage generation unit suitable for receiving the external voltage to drive the internal voltage terminal based on a level of a second reference voltage that is greater than the preset voltage.

In an embodiment, a semiconductor device may include: a first reference voltage generation unit suitable for outputting an external voltage as a first reference voltage, and clamping the first reference voltage based on a first voltage in a positive direction from a ground voltage; a second reference voltage generation suitable for outputting the external voltage as a second reference voltage, and clamping a level of the second reference voltage based on a second voltage in the positive direction from the ground voltage, the second voltage being less than the first voltage; a first internal voltage generation unit suitable for receiving the external voltage to drive a first internal voltage terminal with a first drivability corresponding to the first reference voltage; a second internal voltage generation unit suitable for receiving the external voltage to drive a second internal voltage terminal with a second drivability corresponding to the second reference voltage, the second drivability being less than the first drivability; and a third internal voltage generation unit suitable for receiving the external voltage to drive the first internal voltage terminal based on a third reference voltage that is greater than the first voltage.

### BRIEF DESCRIPTION OF THE DRAWINGS

FIG. 1 is a circuit diagram illustrating an internal voltage generation circuit of a conventional semiconductor device.

FIG. 2 is a timing diagram describing a power-up operation of the conventional semiconductor device illustrated in FIG. 1.

FIG. 3 is a circuit diagram illustrating an internal voltage generation circuit of a semiconductor device in accordance with an embodiment of the present invention.

FIG. 4 is a timing diagram describing a power-up operation of the semiconductor device illustrated in FIG. 3,

FIG. 5 is a circuit diagram illustrating an internal voltage generation circuit of a semiconductor device in accordance with another embodiment of the present invention.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

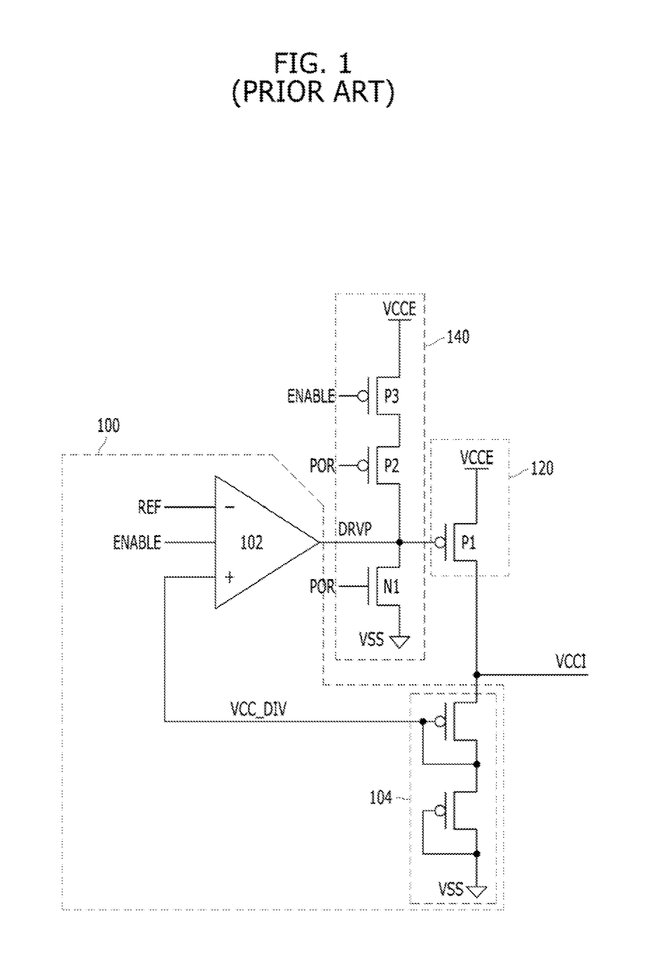

FIG. 1 is a circuit diagram illustrating an internal voltage generation circuit of a conventional semiconductor device.

Referring to FIG. 1, the internal voltage generation circuit of the conventional semiconductor device includes a comparison unit 100, a first coupling control unit 120, and a second coupling control unit 140. The comparison unit 100 may include a voltage comparator 102 and a voltage divider 104.

The comparison unit 100 may compare an internal voltage VCCI with a reference voltage REF, and generate a control signal DRVP whose activation is determined in response to a comparison result. For example, the comparison unit 100 may activate the control signal DRVP when the internal voltage VCCI is less than or equal to the reference voltage REF, and deactivate the control signal DRVP when the internal voltage VCCI is greater than the reference voltage REF.

The voltage divider 104 may divide the internal voltage VCCI by a preset ratio, and generate a divided voltage VCCI_DIV.

The voltage comparator 102 may compare the divided voltage VCCI_DIV with the reference voltage REF, and determine whether to activate the control signal DRVP.

The voltage divider 104 is a component required for reducing current consumption in the operation of the comparison unit 100 The voltage divider 104 may serve to reduce a voltage corresponding to a comparison target. The preset ratio may be selected by a designer.

The first coupling control unit 120 may couple an external voltage (VCCE) terminal to an internal voltage (VCCI) terminal during an active period of the control signal DRVP, and separate the external voltage (VCCE) terminal from the internal voltage (VCCI) terminal during an inactive period of the control signal DRVP.

Specifically, the first coupling control unit 120 may include a PMOS transistor P1 for selecting whether to couple/separate the external voltage (VCCE) terminal coupled to a source terminal to/from the internal voltage (VCCI) terminal coupled to a drain terminal in response to the control signal DRVP inputted through a gate terminal thereof.

The second coupling control unit 140 may forcibly activate the control signal DRVP during a power-up operation period corresponding to an active period of a power-up signal POR, and have no influence on whether to activate the control signal DRVP during a normal operation period.

Specifically, the second coupling control unit 140 may include an NMOS transistor N1 and a PMOS transistor P2, for forcibly activating the control signal DRVP during the active period in which the power-up signal POR is activated to a logic high.

The operation period in which the second coupling control unit 140 forcibly activates the control signal DRVP must not overlap the operation period of the comparison unit 100. Thus, an enable signal ENALBE which is maintained at a logic low during the power-up operation period and activated during the normal operation period, after the power-up operation period, may be inputted to the second coupling control unit 140. That is, when the enable signal ENABLE is maintained at a logic low during the power-up operation period, which the semiconductor device enters immediately after power is supplied, the enable signal ENABLE may prevent the operation of the comparison unit 100. On the other hand, when the semiconductor device enters the normal operation period after exiting from the power-up operation period, the enable signal ENABLE may be activated to a logic high. Thus, the enable signal ENABLE may not only enable the comparison unit 100 to normally operate, but may also, prevent the second coupling control unit 140 from having an influence on whether to activate/deactivate the control signal DRVP. For this operation, the enable signal ENABLE may be inputted to the voltage comparator 102 to control its operation, and be simultaneously inputted to a gate of a PMOS transistor P3 included in the second coupling control unit 140 to control a connection between the second coupling control unit 140 and the external voltage (VCCE) terminal.

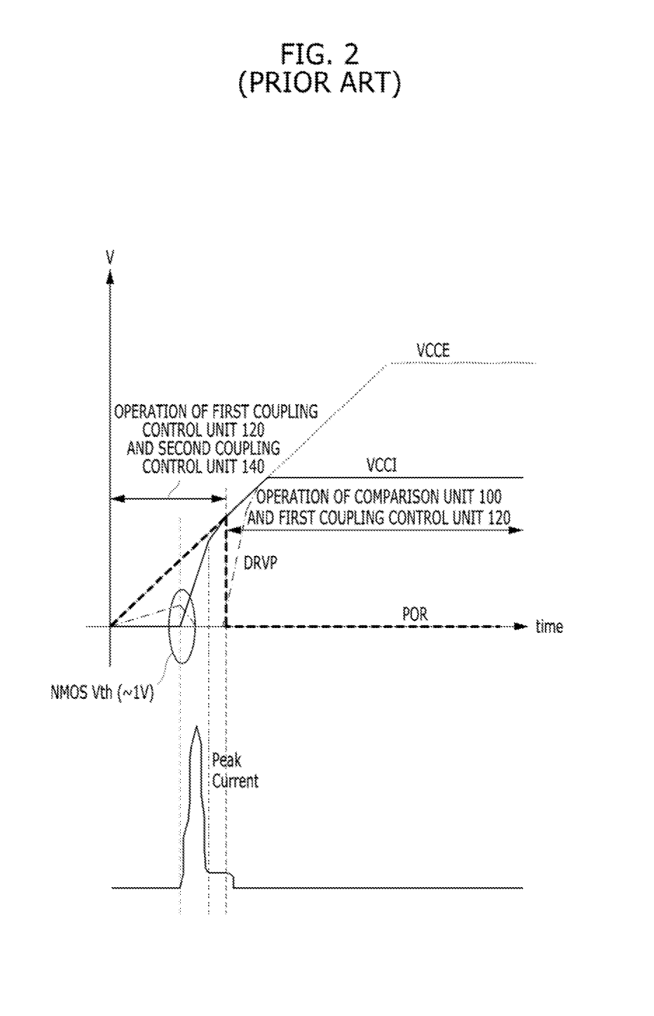

FIG. 2 is a timing diagram describing a power-up operation of the conventional semiconductor device illustrated in FIG. 1.

Referring to FIG. 2, as the external voltage VCCE constantly increases after the supply of the external voltage VCCE is started, the power-up signal POR voltage and the internal voltage VCCI may be sequentially set.

First, the power-up signal POR may constantly increase in the same state as the external voltage VCCE after the supply of the external voltage VCCE is started.

In this state, the enable signal ENABLE may maintain a ground voltage (VSS). Thus, the comparison unit 100 may be disabled to have no influence on the internal voltage VCCI.

On the other hand, the second coupling control unit 140 may constantly increase the control signal DRVP in response to a constant increase in the power-up signal POR. At this time, the voltage of the control signal DRVP may increase less than half that of an increase in the voltage of the power-up signal POR. That is because both the PMOS transistor P2 and the NMOS transistor N1, which are included in the second coupling control unit 140 and affected by the power-up signal POR, have influence on the voltage variation of the power-up signal POR. Thus, the control signal DRVP may be neither activated nor deactivated. Therefore, the external voltage (VCCE) terminal and a ground voltage (VSS) terminal may not be coupled to each other. That is, regardless of whether the external voltage VCCE increases, the internal voltage VCCI may continuously maintain the ground voltage VSS.

Then, when the external voltage VCCE and the power-up signal POR exceed a predetermined voltage, for example, a threshold voltage Vth of the transistor, the voltage of the control signal DRVP may be activated while rapidly dropping to a ground voltage (VSS). That is because, as the voltage of the power-up signal POR continuously increases to reach the predetermined voltage, the PMOS transistor P2 included in the second coupling control unit 140 is reliably turned off and the NMOS transistor Ni is reliably turned on. Thus, the external voltage (VCCE) terminal and the ground voltage (VSS) terminal may be momentarily switched from a state in which the external voltage (VCCE) terminal is coupled to the ground voltage (VSS) terminal, to a stater in which the external voltage (VCCE) terminal is separated from the ground voltage (VSS) terminal. That is, the internal voltage VCCI may rapidly increase toward the external voltage VCCE which has already reached the predetermined voltage,

For reference, the predetermined voltage may be set to 1V as illustrated in the drawing, but may be less or more than 1V. However, before the external voltage VCCE and the power-up signal POR reach the predetermined voltage, the control signal DRVP may not be activated.

Through the above-described process, the external voltage VCCE, the power-up signal POR, and the internal voltage VCCI may equalize. In this state, when the external voltage VCCE increases enough to operate the internal circuits of the semiconductor device, the power-up signal POR may be deactivated to the ground voltage (VSS). Simultaneously, the enable signal ENABLE may be activated to a logic high. That is, the power-up operation period may end. Since the internal voltage VCCI does not reach the target voltage even when the power-up operation period is ended, the internal voltage VCCI may continuously increase while the control signal DRVP is adjusted by the comparison unit 100 and the first coupling control unit 120

Referring back to FIG. 2, the current consumption of the semiconductor device may vary as the internal voltage VCCI varies. That is, the peak current consumed in the semiconductor device may rapidly vary.

Specifically, regardless of the increase in the external voltage VCCE the semiconductor device may consume no current during a period in which the internal voltage VCCI maintains the ground voltage (VSS).

Then, when the internal voltage VCCI rapidly increases at the time at which the external voltage VCCE exceeds the predetermined voltage, the current consumption of the semiconductor device may rapidly increase.

Then, when the external voltage VCCE is equalized to the internal voltage VCCI, the current consumption of the semiconductor device may rapidly stabilize. Furthermore, even after the internal voltage VCCI reaches the target voltage, the current consumption of the semiconductor device may maintain the stabilized state.

As described above, the current consumption of the conventional semiconductor device may rapidly increase during the power-up operation period of the semiconductor device. Such a phenomenon may occur as the external voltage VCCE rapidly increases, and have an adverse influence on a plurality of internal circuits included in the semiconductor device.

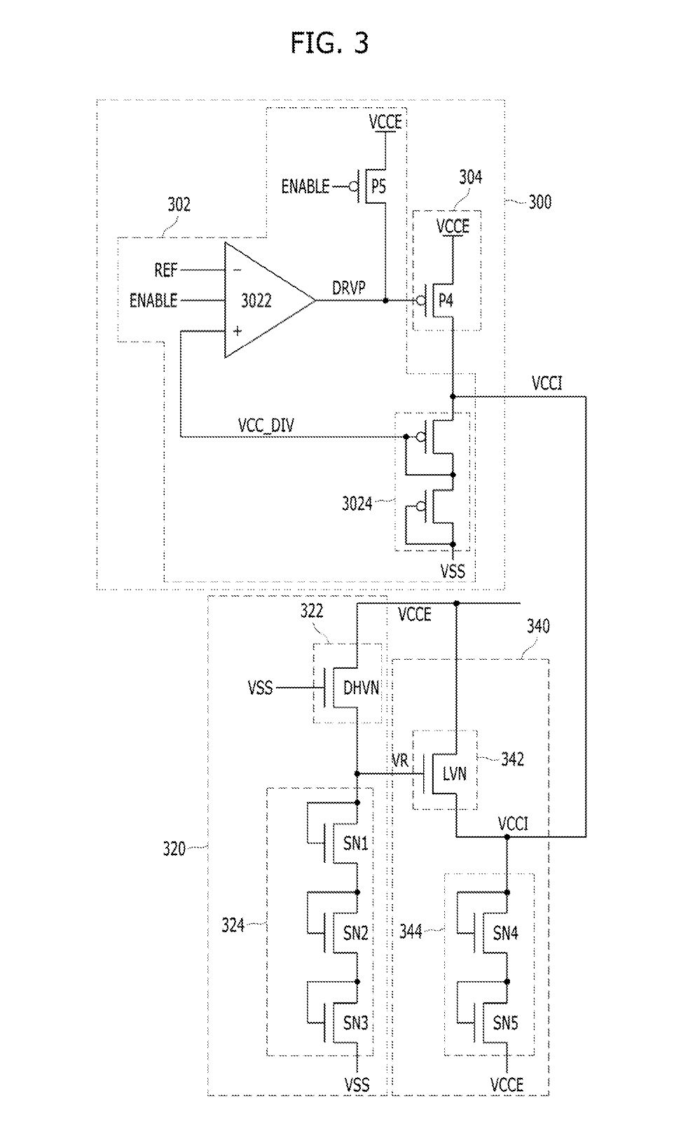

FIG. 3 is a circuit diagram illustrating an internal voltage generation circuit of a semiconductor device in accordance with an embodiment of the present invention.

Referring to FIG. 3, the internal voltage generation circuit of the semiconductor device in accordance with the embodiment of the present invention may include a first reference voltage generation unit 320, a first internal voltage generation unit 340, and a second internal voltage generation unit 300. The first reference voltage generation unit 320 may include a depletion-type NMOS transistor (DHVN) 322 and a first sinking unit 324. The first internal voltage generation unit 340 may include an NMOS transistor (LVN) 342 and a second sinking unit 344. The second internal voltage generation unit 300 may include a comparison unit 302 and a coupling control unit 304. The comparison unit 302 may include a voltage comparator 3022 and a voltage divider 3024.

The first reference voltage generation unit 320 may output an external voltage VCCE as a first reference voltage VR, and clamp the first reference voltage VR based on a voltage shifted by a preset voltage in a positive direction from a ground voltage (VSS).

That is, the first reference voltage generation unit 320 may output the first reference voltage VR having the same voltage as the external voltage VCCE, during a period in which the external voltage VCCE is less than or equal to the voltage shifted by the preset voltage in the positive direction from the ground voltage (VSS). On the other hand, the first reference voltage generation unit 320 may clamp the first reference voltage VR to the voltage shifted by the preset voltage in the positive direction from the ground voltage (VSS), during a period in which the external voltage VCCE is greater than the voltage shifted by the preset voltage in the positive direction from the ground voltage (VSS).

For this operation, the first reference voltage generation unit 320 may include the depletion-type NMOS transistor 322 which fixes a gate terminal to the ground voltage (VSS) when a threshold voltage thereof is shifted by a preset voltage in a negative direction from the ground voltage (VSS), and adjusts the first reference voltage VR coupled to a source terminal in response to a variation in the external voltage VCCE coupled to a drain terminal thereof.

That is, the first reference voltage generation unit 320 may control voltage variation of the first reference voltage VR based on the voltage variation of the external voltage VCCE, using the depletion-type NMOS transistor 322 having a negative (−) threshold voltage. Specifically, while the depletion-type NMOS transistor 322 included in the first reference voltage generation unit 320 has the negative threshold voltage, a ground voltage VSS may be supplied to the gate terminal. Thus, when the external voltage VCCE inputted to the source terminal is between the ground voltage (VSS) and a positive threshold voltage, the depletion-type NMOS transistor 322 may set the external voltage VCCE inputted to the source terminal to the first reference voltage VR outputted to the drain terminal. However, during a period in which the external voltage VCCE inputted to the source terminal exceeds the positive threshold voltage the depletion-type NMOS transistor 322 may fix the first reference voltage VR outputted to the drain terminal to the positive threshold voltage, regardless of the external voltage VCCE. For reference, the negative threshold voltage may indicate a voltage shifted by the preset voltage in the negative direction from the ground voltage (VSS). Similarly, the positive threshold voltage may indicate a voltage shifted by the preset voltage in the positive direction from the ground voltage (VSS).

For example, suppose that the depletion-type NMOS transistor 322 included in the first reference voltage generation unit 320 has a threshold voltage of −2.5V. In this case, during a period in which the external voltage VCCE varies from the ground voltage (VSS) to 2.5V, the external voltage VCCE may be set to the reference voltage VR. However, during a period in which the external voltage VCCE exceeds 2.5V, the first reference voltage VR may be fixed to 2.5V, regardless of the external voltage VCCE.

The first reference voltage generation unit 320 may further include the first sinking unit 324 in addition to the depletion-type NMOS transistor 322. Specifically, the first sinking unit 324 may sink a leakage current from the depletion-type NMOS transistor 322 to a ground voltage (VSS) terminal, the leakage current flowing from the source terminal of the depletion-type NMOS transistor 322, that is, a first reference voltage (VR) terminal. For this operation, the first sinking unit 324 may be coupled between the ground voltage (VSS) terminal and the source terminal of the depletion-type NMOS transistor 322, that is, the first reference voltage (VR) terminal. The first sinking unit 324 may include a plurality of diode-type NMOS transistors SN1, SN2, and SN3 coupled in series. Each of the diode-type NMOS transistors SN1, SN2, and SN3 may be coupled toward the first reference voltage (VR) terminal in such a manner that the gate and drain terminals thereof are coupled to each other between the first reference voltage (VR) terminal and the ground voltage (VSS) terminal, and operate as a backward diode. Thus, the first sinking unit 324 may prevent the first reference voltage VR from increasing to a greater voltage than the positive threshold voltage due to the leakage current flowing from the depletion-type NMOS transistor 322.

The first internal voltage generation unit 340 may receive the external voltage VCCE, and drive an internal voltage (VCCI) terminal with a drivability corresponding to the first reference voltage VR.

For this operation, the first internal voltage generation unit 340 may include an NMOS transistor (LVN) 342 for adjusting a current flowing between the external voltage (VCCE) terminal coupled to a drain terminal and the internal voltage (VCCI) terminal coupled to a source terminal, in response to the first reference voltage VR applied to a gate terminal thereof.

The first internal voltage generation unit 340 may further include a second sinking unit 344 in addition to the NMOS transistor 342. Specifically, when an internal voltage VCCI is greater than the external voltage VCCE, for example, when the external voltage VCCE rapidly drops in a power-off state, the second sinking unit 344 may sink current from the internal voltage (VCCI) terminal to the external voltage (VCCE) terminal. For this operation, the second sinking unit 344 may be coupled between the external voltage (VCCE) terminal and the source terminal of the NMOS transistor 342, that is, the internal voltage (VCCI) terminal. The second sinking unit 344 may include a plurality of diode-type NMOS transistors SN4 and SN5 coupled in series. Each of the diode-type NMOS transistors SN4 and SN5 may be coupled toward the internal voltage (VCCI) terminal in such a manner that the gate and drain terminals thereof are coupled to each other between the internal voltage (VCCI) terminal and the external voltage (VCCE) terminal, and operate as a backward diode. Thus, when the internal voltage VCCI is greater than the external voltage VCCE, the second sinking unit 344 may rapidly lower the internal voltage VCCI to a stable state.

The second internal voltage generation unit 300 may receive the external voltage VCCE to drive the internal voltage (VCCI) terminal, based on a second reference voltage REF, which is greater than the preset voltage in the positive direction from the ground voltage (VSS).

The comparison unit 302 may compare the internal voltage VCCI with the second reference voltage REF, and generate a control signal DRVP whose activation is determined in response to an enable signal ENABLE activated after a power-up operation period. For example, when the enable signal ENABLE is activated, the comparison unit 302 may activate the control signal DRVP when the internal voltage VCCI is less than or equal to the second reference voltage REF, and deactivate the control signal DRVP when the internal voltage VCCI is greater than the second reference voltage REF.

The voltage divider 3024 may divide the internal voltage VCCI by a preset ratio, and generate a divided voltage VCCI_DIV.

The voltage comparator 3022 may compare the divided voltage VCCI_DIV with the second reference voltage REF, and determine whether to activate the control signal DRVP.

The voltage divider 3024 is a component required for reducing current consumption in the operation of the comparison unit 302. The voltage divider 3024 may serve to reduce a voltage corresponding to a comparison target. The preset ratio may be selected by the designer.

For reference, when the voltage divider 3024 is included in the comparison unit 302, an absolute value of the second reference voltage REF applied to the comparison unit 302 may be less than or equal to the positive threshold voltage. However, a logic value of the second reference voltage REF used for detecting the internal voltage VCCI in the operation of the comparison unit 302 may become greater than the positive threshold voltage. Thus, when the second reference voltage REF is greater than the positive threshold voltage in the descriptions for the operation of the second internal voltage generation unit 300, it may indicate that the logic value of the second reference voltage REF is greater than the positive threshold voltage. When the voltage divider 3024 is not included in the comparison unit 302, the absolute value of the second reference voltage REF may become greater than the positive threshold voltage.

The comparison unit 302 may further include a PMOS transistor P5 which is turned on in response to the enable signal ENABLE.

The coupling control unit 304 may couple the external voltage (VCCE) terminal to the internal voltage (VCCI) terminal during an active period of the control signal DRVP, and separate the external voltage (VCCE) terminal from the internal voltage VCCI during an inactivate period of the control signal DRVP.

Specifically, the coupling control unit 304 may include a PMOS transistor P4 for selecting whether to couple/separate the external voltage (VCCE) terminal coupled to a source terminal to/from the internal voltage (VCCI) terminal coupled to a drain terminal, in response to the control signal DRVP inputted through a gate terminal thereof.

Furthermore, the enable signal ENABLE may have an influence on whether to activate the control signal DRVP generated through the comparison unit 302. The enable signal ENABLE may be maintained at a logic low during the power-up operation period, and activated to a logic high during a normal operation period after the power-up operation period. That is, only when the enable signal ENABLE is activated to a logic high may the comparison unit 302 determine whether to activate the control signal DRVP. This is in order to reliably separate the operation period of the second internal voltage generation unit 300.

Specifically, since a normal operation of the second internal voltage generation unit 300 may not be guaranteed during the power-up operation period in which the external voltage VCCE is not sufficiently high, the enable signal ENABLE may be used to disable the second internal voltage generation unit 300. Thus, the second internal voltage generation unit 300 may be configured to operate only during the normal operation period after the power-up operation period.

Furthermore, the first reference voltage generation unit 320 and the first internal voltage generation unit 340 may be designed to normally operate at all times, regardless of entering the power-up operation period in which the external voltage VCCE is not sufficiently high. That is, when the external voltage VCCE is less than or equal to a voltage shifted by the preset voltage in the positive direction from the ground voltage (VSS), regardless of entering the power-up operation period, the first reference voltage generation unit 320 and the first internal voltage generation unit 340 may vary the first reference voltage VR, according to the variation of the external voltage VCCE and d rive the internal voltage (VCCI) terminal with a drivability varying according to the variation of the first reference voltage VR. Furthermore, when the external voltage VCCE is greater than the preset voltage, regardless of entering the power-up operation period, the first reference voltage generation unit 320 and the first internal voltage generation unit 340 may fix the first reference voltage VR to the preset voltage, regardless of the variation of the external voltage VCCE, and drive the internal voltage (VCCI) terminal with a drivability which is fixed according to the first reference voltage VR.

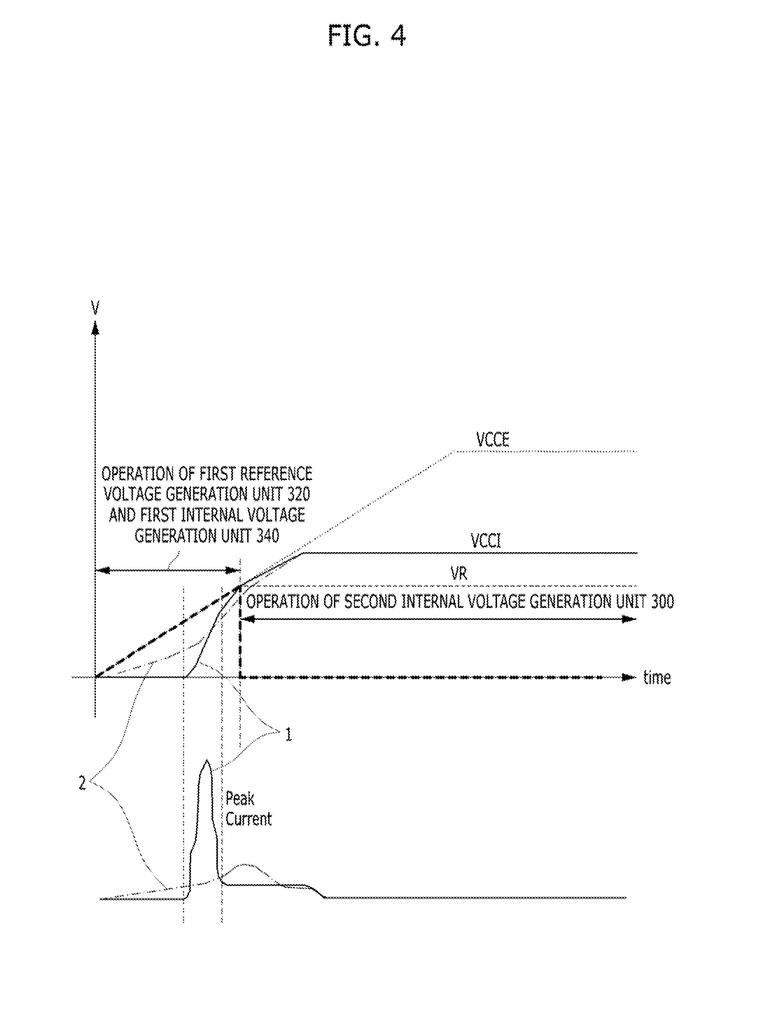

FIG. 4 is a timing diagram describing a power-up operation of the semiconductor device illustrated in FIG. 3.

Referring to FIG. 4, as the external voltage VCCE constantly increases after the supply of the external voltage VCCE is started, the internal voltage VCCI may be sequentially set.

First, the first reference voltage VR may constantly increase in the same manner as the external voltage VCCE after the supply of the external voltage VCCE is started.

In this state, the enable signal ENABLE may maintain the ground voltage (VSS). Thus, the voltage comparator 3022 may be disabled and the second internal voltage generation unit 300 may have no influence on the internal voltage VCCI.

On the other hand, the first reference voltage generation unit 320 and the first internal voltage generation unit 340 may gradually increase the internal voltage VCCI in response to a constant increase of the first reference voltage VR. At this time, the internal voltage VCCI may have an increase of less than a half of an increase in the external voltage VCCE. This is because the NMOS transistor 342 included in the first internal voltage generation unit 340 also has the positive threshold voltage. That is, the increase in the first reference voltage VR applied to the gate terminal of the NMOS transistor 342 included in the first internal voltage generation unit 340 may not be applied as the increase in the internal voltage VCCI. Furthermore, the NMOS transistor 342 may increase the internal voltage VCCI even when the first reference voltage VR is less than the threshold voltage of the NMOS transistor 342. This is because the NMOS transistor 342 does not operate in an ideal state where the NMOS transistor 342 has only a turn-on/off state in response to the variation of the first reference voltage VR, but may vary a current flowing between the external voltage (VCCE) terminal and the internal voltage (VCCI) terminal in response to the variation of the first reference voltage VR That is, when a period in which the first reference voltage VR increases overlaps a period in which the first reference voltage VR is less than or equal to the threshold voltage of the NMOS transistor 342, the current flowing between the external voltage (VCCE) terminal and the internal voltage (VCCI) terminal may gradually increase. However, when the period in which the first reference voltage VR increases overlaps the period in which the first reference voltage VR is greater than the threshold voltage of the NMOS transistor 342, the current flowing between the external voltage (VCCE) terminal and the internal voltage (VCCI) terminal may significantly increase. Thus, while the first reference voltage VR constantly increases, the internal voltage VCCI may increase in the form of a quadratic equation.

Through the above-described process, the external voltage VCCE, the first reference voltage VR, and the internal voltage VCCI may be equalized. In this state, when the external voltage VCCE further increases enough to operate the internal circuits of the semiconductor device, the enable signal ENABLE may be activated to a logic high, and the first reference voltage VR may be clamped so as not to increase any more. At this time, since the internal voltage VCCI does not reach the target voltage even when the power-up operation period is ended, the internal voltage VCCI may continuously increase while the control signal DRVP is adjusted by the second internal voltage generation unit 300.

Referring back to FIG. 4, the current consumption of the semiconductor device may vary as the internal voltage VCCI varies. That is, the peak current consumed in the semiconductor device may be gradually varied.

Specifically, during a period in which the internal voltage VCCI gradually increases in response to the increase in the external voltage VCCE, the current consumption of the semiconductor device may gradually increase. That is, during a period in which the first reference voltage VR does not exceed the threshold voltage of the NMOS transistor 342 included in the first internal voltage generation unit 340, the internal voltage VCCI may gradually increase. Thus, the current consumption of the semiconductor device may gradually increase.

Then, after the external voltage VCCE exceeds a predetermined voltage, that is, the first reference voltage VR exceeds the threshold voltage of the NMOS transistor 342 included in the first internal voltage generation unit 340, the internal voltage VCCI may increase at higher speed than in the previous period. Thus, the current consumption of the semiconductor device may rapidly increase.

However, since the first internal voltage generation unit 340 normally operates to increase the internal voltage VCCI to some extent before the external voltage VCCE exceeds the predetermined voltage, a rapid increase in the internal voltage VCCI may not occur even though the external voltage VCCE does not exceed the predetermined voltage.

Thus, graph 2 indicating the current consumption of the semiconductor device in accordance with the embodiment of the present invention has a more gentle slope than graph 1 indicating the current consumption of the semiconductor device illustrated in FIG. 2. In particular, the peak current of the graph 2 if profoundly different from the peak current of the graph 1.

The current consumption of the semiconductor device may be gradually stabilized even after the external voltage VCCE is equalized to the internal voltage VCCI. Furthermore, even after the internal voltage VCCI reaches the target voltage, the current consumption of the semiconductor device may maintain a stabilized state.

As described above, even when the external voltage VCCE is extremely low during the power-up operation period, the semiconductor device in accordance with the embodiment of the present invention may reflect the external voltage VCCE onto the internal voltage VCCI. Thus, even during the power-up operation period, the current consumption of the semiconductor device may gradually increase.

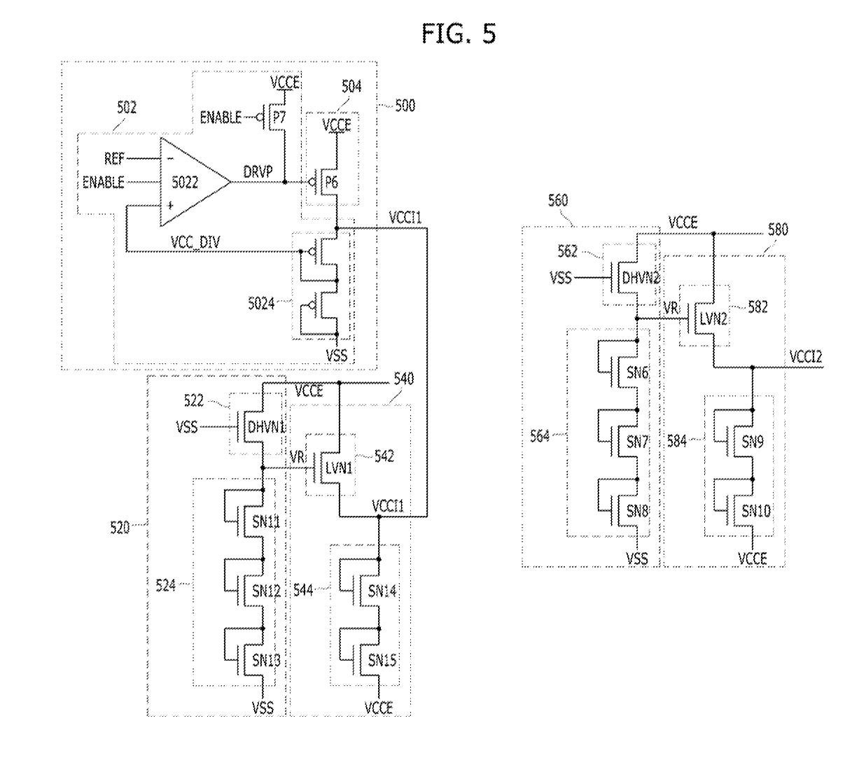

FIG. 5 is a circuit diagram illustrating an internal voltage generation circuit of a semiconductor device in accordance with another embodiment of the present invention.

Referring to FIG. 5, the internal voltage generation circuit of the semiconductor device in accordance with the embodiment of the present invention may include a first reference voltage generation unit 520, a first internal voltage generation unit 540, a second reference voltage generation unit 560, a second internal voltage generation unit 580, and a third internal voltage generation unit 500. The first reference voltage generation unit 520 may include a first depletion-type NMOS transistor (DHVN1) 522 and a first sinking unit 524. The first internal voltage generation unit 540 may include a first NMOS transistor (LVN1) 542 and a second sinking unit 544. The second reference voltage generation unit 560 may include a second depletion-type NMOS transistor (DHVN2) 562 and a third sinking unit 564. The second internal voltage generation unit 580 may include a second NMOS transistor (LVN2) 582 and a fourth sinking unit 584. The third internal voltage generation unit 500 may include a comparison unit 502 and a coupling control unit 504. The comparison unit 502 may include a voltage comparator 5022 and a voltage divider 5024.

The first reference voltage generation unit 520 may output an external voltage VCCE as a first reference voltage VR1 and damp the first reference voltage VR1 based on a voltage shifted by a first voltage in a positive direction from a ground voltage (VSS).

That is, the first reference voltage generation unit 520 may output the first reference voltage VRI having the same voltage as the external voltage VCCE, during a period in which the external voltage VCCE is less than or equal to the voltage shifted by the first voltage in the positive direction from the ground voltage (VSS). On the other hand, the first reference voltage generation unit 520 may clamp the io first reference voltage VR1 to the voltage shifted by the first voltage in the positive direction from the ground voltage (VSS), during a period in which the external voltage VCCE is greater than the voltage shifted by the first voltage in the positive direction from the ground voltage (VSS).

For this operation, the first reference voltage generation unit 520 may include the first depletion-type NMOS transistor 522 which fixes a gate terminal to the ground voltage (VSS) when a threshold voltage thereof is shifted by the first voltage in a negative direction from the ground voltage (VSS), and adjusts the first reference voltage VR1 coupled to a source terminal in response to a variation of the external voltage VCCE coupled to a drain terminal.

That is, the first reference voltage generation unit 520 may control the variation of the first reference voltage VR1 based on the variation of the external voltage VCCE, using the first depletion-type NMOS transistor 522 having a first negative threshold voltage. Specifically, when the first depletion-type NMOS transistor 522 included in the first reference voltage generation unit 520 has the first negative threshold voltage, a ground voltage VSS may be supplied to the gate terminal thereof. Thus, when the external voltage VCCE inputted to the source terminal is between the ground voltage (VSS) and a first positive threshold voltage, the first depletion-type NMOS transistor 522 may set the external voltage VCCE inputted to the source terminal to the first reference voltage VR1 outputted to the drain terminal. However, during a period in which the external voltage VCCE inputted to the source terminal exceeds the first positive threshold voltage, the first depletion-type NMOS transistor 522 may fix the first reference voltage VR1 outputted to the drain terminal to the first positive threshold voltage, regardless of the external voltage VCCE. For reference, the first negative threshold voltage may indicate a voltage shifted by the first, voltage in the negative direction from the ground voltage (VSS), Similarly, the first positive threshold voltage may indicate a voltage shifted by the first voltage in the positive direction from the ground voltage (VSS).

For example, suppose that the threshold voltage of the first depletion-type NMOS transistor 522 included in the first reference voltage generation unit 520 is −2.5V. In this case, during a period in which the external voltage VCCE varies from the ground voltage (VSS) to 2.5V, the external voltage VCCE may be set to the first reference voltage VR1. However, during a period in which the external voltage VCCE exceeds 2.5V, the first reference voltage VR1 may be fixed to 2.5V, regardless of the external voltage VCCE.

The first reference voltage generation unit 520 may further include the first sinking unit 524 in addition to the first depletion-type NMOS transistor 522. Specifically, the first sinking unit 524 may sink a leakage current from the first depletion-type NMOS transistor 522 to the ground voltage (VSS) terminal, and the leakage current flowing from the source terminal of the first depletion-type NMOS transistor 522, that is, the first reference voltage (VR1) terminal. For this operation, the first sinking unit 524 may be coupled between the ground voltage (VSS) terminal and the source terminal of the first depletion-type NMOS transistor 522, that is, the first reference voltage (VR1) terminal. The first sinking unit 524 may include a plurality of diode-type NMOS transistors SN1, SN2, SN3 coupled in series. Each of the diode-type NMOS transistors SN1, SN2, and SN3 may be coupled toward the first reference voltage (VR1) terminal in a such a manner that the gate and drain terminals thereof are coupled to each other between the first reference voltage (VR1) terminal and the ground voltage (VSS) terminal, and operate as a backward diode. Thus, the first sinking unit 524 may prevent the first reference voltage VR1 from increasing to a higher voltage than the first positive threshold voltage due to the leakage current flowing from the first depletion-type NMOS transistor 522.

The first internal voltage generation unit 540 mayreceive the external voltage VCCE, and drive a first internal voltage (VCCI1) terminal with a first drivability corresponding to the first reference voltage VR1.

For this operation, the first internal voltage generation unit 540 may include the first NMOS transistor 542 for adjusting a current flowing between the external voltage (VCCE) terminal coupled to a drain terminal and the first internal voltage (VCCI1) terminal coupled to a source terminal, in response to the first reference voltage VR1 applied to a gate terminal thereof.

The first internal voltage generation unit 540 may further include the second sinking unit 544 in addition to the first NMOS transistor 542. Specifically, when a first internal voltage VCCI1 is greater than the external voltage VCCE, for example, when the external voltage VCCE rapidly drops in a power-off state, the second sinking unit 544 may sink current from the first internal voltage (VCCI1) terminal to the external voltage (VCCE) terminal. For this operation, the second sinking unit 544 may be coupled between the external voltage (VCCE) terminal and the source terminal of the first NMOS transistor 542, that is, the first internal voltage (VCCI1) terminal. That is, the second sinking unit 544 may include a plurality of diode-type NMOS transistors SN4 and SN5 coupled in series. Each of the diode-type NMOS transistors SN4 and SN5 may be coupled toward the first internal voltage (VCCI1) terminal in such a manner that the gate and drain terminals thereof are coupled to each other between the first internal voltage (VCCI1) terminal and the external voltage (VCCE) terminal, and operate as a backward diode. Thus, when the first internal voltage VCCI1 is greater than the external voltage VCCE, the second sinking unit 544 may rapidly lower the first internal voltage VCCI1 to a stable state.

The second reference voltage generation unit 560 may output the external voltage VCCE as a second reference voltage VR2, and clamp the second reference voltage VR2 based on a voltage shifted by a second voltage in the positive direction from the ground voltage (VSS). At this time, the second voltage may be less than the first voltage.

That is, the second reference voltage generation unit 560 may output the second reference voltage VR2 having the same voltage as the external voltage VCCE, during a period in which the external voltage VCCE is less than or equal to the voltage shifted by the second voltage in the positive direction from the ground voltage (VSS). On the other hand, the second reference voltage generation unit 560 may clamp the second reference voltage VR2 to the voltage shifted by the second voltage in the positive direction from the ground voltage (VSS), during a period in which the external voltage VCCE is greater than the voltage shifted by the second voltage in the positive direction from the ground voltage (VSS).

For this operation, the second reference voltage generation unit 560 may include the second depletion-type NMOS transistor 562 which fixes a gate terminal to the ground voltage (VSS) when a threshold voltage thereof is shifted by the second voltage in a negative direction from the ground voltage (VSS), and adjusts the second reference voltage VR2 coupled to a source terminal in response to the variation of the external voltage VCCE coupled to a drain terminal thereof.

That is, the second reference voltage generation unit 560 may control a variation of the second reference voltage VR2 based on the variation of the external voltage VCCE, using the second depletion-type NMOS transistor 562 having a second negative threshold voltage. Specifically, when the second depletion-type NMOS transistor 562 included in the second reference voltage generation unit 560 has the second negative threshold voltage, the ground voltage VSS may be supplied to the gate terminal thereof. Thus, when the external voltage VCCE inputted to the source terminal is between the ground voltage (VSS) and a second positive threshold voltage, the second depletion-type NMOS transistor 562 may set the external voltage VCCE inputted to the source terminal to the second reference voltage VR2 outputted to the drain terminal. However, during a period in which the external voltage VCCE inputted to the source terminal exceeds the second positive threshold voltage, the second depletion-type NMOS transistor 562 may fix the second reference voltage VR2 outputted to the drain terminal to the second positive threshold voltage, regardless of the external voltage VCCE. For reference, the second negative threshold voltage may indicate a voltage shifted by the second voltage in the negative direction from the ground voltage (VSS). Similarly, the second positive threshold voltage may indicate a voltage shifted by the second voltage in the positive direction from the ground voltage (VSS).

For example, suppose that the threshold voltage of the second depletion-type NMOS transistor 562 included in the second reference voltage generation unit 560 is −2.3V. In this case, during a period in which the external voltage VCCE varies from the ground voltage VSS to 2.3V, the external voltage VCCE may be set as the second reference voltage VR2. However, during a period in which the external voltage VCCE exceeds 2.3V, the second reference voltage VR2 may be fixed to 2.3V, regardless of the external voltage VCCE.

The second reference voltage generation unit 560 may further include the third sinking unit 564 in addition to the second depletion-type NMOS transistor 562. Specifically, the third sinking unit 564 may sink a leakage current from the second depletion-type NMOS transistor 562 to the ground voltage (VSS) terminal, and the leakage current flowing from the source terminal of the second depletion-type NMOS transistor 562, that is, the second reference voltage (VR2) terminal. For this operation, the third sinking unit 564 may be coupled between the ground voltage (VSS) terminal and the source terminal of the second depletion-type NMOS transistor 562, that is, the second reference voltage (VR2) terminal. The third sinking unit 564 may include a plurality of diode-type NMOS transistors SNS, SN7, and SN8 coupled in series. Each of the diode-type NMOS transistors SNS, SN7, and SN8 may be coupled toward the second reference voltage (VR2) terminal in such a manner that the gate and drain terminals thereof are coupled to each other between the second reference voltage (VR2) terminal and the ground voltage (VSS) terminal, and operate as a backward diode. Thus, the third sinking unit 564 may prevent the second reference voltage (VR2) terminal from increasing to a higher voltage than the second positive threshold voltage due to the leakage current flowing from the second depletion-type NMOS transistor 562.

The second internal voltage generation unit 580 may receive the external voltage VCCE, and drive a second internal voltage (VCCI2) terminal with a second drivability corresponding to the second reference voltage VR2. At this time, the second drivability of the second internal voltage generation unit 580 may be smaller than the first drivability of the first internal voltage generation unit 540. That is, when the external voltage VCCE becomes less than the first and second voltages such that the first and second reference voltages VR1 and VR2 have the same voltage, the first drivability of the first internal voltage generation unit 540 to drive the first internal voltage VCCI1 may be greater than the second drivability of the second internal voltage generation unit 580 to drive the second internal voltage (VCCI2) terminal. That is because, since the first and second internal voltages VCCI1 and VCCI2 are used for different purposes, the first and second internal voltage generation units 540 and 580 may be set to have different configurations. The detailed configurations will be described below.

For this operation, the second internal voltage generation unit 580 may include a second NMOS transistor 582 for adjusting a current flowing between the external voltage (VCCE) terminal coupled to a drain terminal and the second internal voltage (VCCl2) terminal coupled to a source terminal, in response to the second reference voltage VR2 applied to a gate terminal.

The second internal voltage generation unit 580 may further include the fourth sinking unit 584 in addition to the second NMOS transistor 582. Specifically, when a second internal voltage VCCI2 is higher than the external voltage VCCE, for example, when the external voltage VCCE rapidly drops in a power-off state, the fourth sinking unit 584 may sink current from the second internal voltage (VCCI2) terminal to the external voltage (VCCE) terminal. For this operation, the fourth sinking unit 584 may be coupled between the external voltage (VCCE) terminal and the source terminal of the second NMOS transistor 582, that is, the second internal voltage (VCCI2) terminal. That is, the fourth sinking unit 584 may include a plurality of diode-type NMOS transistors SN9 and SN10 coupled in series. Each of the diode-type NMOS transistors SN9 and SN10 may be coupled toward the second internal voltage (VCCI2) terminal in such a manner that the gate and drain terminals thereof are coupled to each other between the second internal voltage (VCCI2) terminal and the external voltage (VCCE) terminal, and operate as a backward diode. Thus, when the second internal voltage VCCI2 is higher than the external voltage VCCE, the fourth sinking unit 584 may rapidly lower the second internal voltage VCCI2 to a stable state.

The third internal voltage generation unit 500 may receive the external voltage VCCE to drive the first internal voltage (VCCI1) terminal, based on a third reference voltage REF, which is higher than the first voltage in the positive direction from the ground voltage (VSS).

The comparison unit 502 may compare the first internal voltage VCCI1 with the third reference voltage REF, and generate a control signal DRVP whose activation is determined in response to an enable signal ENABLE activated after a power-up operation period. For example, when the enable signal ENABLE is activated, the comparison unit 502 may activate the control signal DRVP when the first internal voltage VCCI1 is less than or equal to the third reference voltage REF, and deactivate the control signal DRVP when the first internal voltage VCCI1 is higher than the third reference voltage REF.

The voltage divider 5024 may divide the first internal voltage VCCI1 by a preset ratio, and generate a divided voltage VCCI_DIV.

The voltage comparator 5022 may compare the divided voltage VCCI_DIV with the third reference voltage REF, and determine whether to activate the control signal DRVP.

The voltage divider 5024 is a component required for reducing current consumption in the operation of the comparison unit 502. The voltage divider 5024 may serve to reduce a voltage corresponding to a target voltage. The preset ratio may be selected by a designer.

For reference, when the voltage divider 5024 is included in the comparison unit 502, an absolute value of the third reference voltage REF applied to the comparison unit 502 may be less than or equal to the first positive threshold voltage. However, a logic value of the third reference voltage REF used for detecting the first internal voltage VCCI1 in the operation of the comparison unit 502 may become higher than the first positive threshold voltage. Thus, when the third reference voltage REF is greater than the first positive threshold voltage in the descriptions for operation of the third internal voltage generation unit 500, it may indicate that the logic value of the third reference voltage REF is greater than the first positive threshold voltage. Furthermore, when the voltage divider 5024 is not included in the comparison unit 502, the absolute value of the third reference voltage REF may become greater than the first positive threshold voltage.

The comparison unit 502 may further include a PMO transistor P7 which is turned on in response to the enable signal ENABLE.

The coupling control unit 504 may couple the external voltage (VCCE) terminal to the first internal voltage (VCCI1) terminal during an active period of the control signal DRVP, and separate the external voltage (VCCE) terminal from the first internal voltage VCCI1 during an inactive period of the control signal DRVP.

Specifically, the coupling control unit 504 may include a PMOS transistor P6 for selecting whether to couple/separate the external voltage (VCCE) terminal coupled to a source terminal to/from the first internal voltage (VCCI1) terminal coupled to a drain terminal, in response to the control signal DRVP inputted through a gate terminal thereof.

Furthermore, the enable signal ENABLE may have an influence on whether to activate the control signal DRVP generated through the comparison unit 502. The enable signal ENABLE may be maintained at a logic low during the power-up operation period, but activated to a logic high during a normal operation period after the power-up operation period. That is, the comparison unit 502 may operate to determine whether to activate the control signal DRVP only when the enab e signal ENABLE is activated to a logic high. This is in order to reliably separate the operation period of the third internal voltage generation unit 500.

Specifically, since a normal operation of the third internal voltage generation unit 500 may not be guaranteed during the power-up operation period in which the external voltage VCCE is not sufficiently high, the enable signal ENABLE may be used to disable the third internal voltage generation unit 500. Thus, the third internal voltage generation unit 500 may be configured to operate only during the normal operation period after the power-up operation period.

Furthermore, the first reference voltage generation unit 520 and the first internal voltage generation unit 540 may be designed to normally operate at all times, regardless of entering the power-up operation period in which the external voltage VCCE is not sufficiently high. That is, when the external voltage VCCE is less than or equal to a voltage shifted by the first voltage in the positive direction from the ground voltage (VSS), regardless of entering the power-up operation period, the first reference voltage generation unit 520 and the first internal voltage generation unit 540 may vary the first reference voltage VR1 according to the variation of the external voltage VCCE, and drive the first internal voltage (VCCI) terminal with the first drivability which varies according to the variation of the first reference voltage VR1. Furthermore, when the external voltage VCCE is greater than the first voltage in the positive direction from the ground voltage (VSS), regardless of entering the power-up operation period, the first reference voltage generation unit 520 and the first internal voltage generation unit 540 may fix the first reference voltage VR1 to the first voltage, regardless of variation in the external voltage VCCE, and drive the first internal voltage (VCCI1) terminal with the first drivability which is fixed according to the fixed voltage of the first reference voltage VR1.

Similarly, the second reference voltage generation unit 560 and the second internal voltage generation unit 580 may be designed to normally operate at all times, regardless of entering the power-up operation period in which the external voltage VCCE is not sufficiently high. That is, when the external voltage VCCE is less than the second voltage in the positive direction from the ground voltage (VSS), regardless of entering the power-up operation period, the second reference voltage generation unit 560 and the second internal voltage generation unit 580 may vary the second reference voltage VR2 according to the variation of the external voltage VCCE, and drive the second internal voltage (VCCI2) terminal with the second drivability varying according to the variation of the second reference voltage VR2. Furthermore, when the external voltage VCCE is greater than the second voltage in the positive direction from the ground voltage (VSS), regardless of whether entering the power-up operation period, the second reference voltage generation unit 560 and the second internal voltage generation unit 580 may fix the second reference voltage VR2 to the second voltage, regardless of the variation of the external voltage VCCE, and drive the second internal voltage (VCCI2) terminal with the second drivability which is fixed according to the fixed voltage of the second reference voltage VR2.

The semiconductor device in accordance with the embodiment of the present invention has the first internal voltage (VCCI1) terminal and the second internal voltage (VCCI2) terminal separated from each other. Furthermore, the first internal voltage VCCI1 may be defined by the operations of the first reference voltage generation unit 520, the first internal voltage generation unit 540, and the third internal voltage generation unit 500. On the other hand, the second internal voltage VCCI2 may be defined by the second reference voltage generation unit 560 and the second internal voltage generation unit 580.

At this time, the functions and operations of the first and second reference voltage generation units 520 and 560 are different from each other, but the configurations of the first and second reference voltage generation units 520 and 560 are very similar to each other. Similarly, the functions and operations of the first and second internal voltage generation units 540 and 580 are different from each other, but the configurations of the first and second internal voltage generation units 540 and 580 are very similar to each other.

The reason why the circuits, for generating the first and second internal voltages VCCI1 and VCCI2 while separating the first internal voltage (VCCI1) terminal from the second internal voltage (VCCI2) terminal, have configurations similar to each other is that the first and second internal voltages VCCI1 and VCCI2 are used in different manners in the semiconductor device in accordance with the embodiment of the present invention.

First, the first internal voltage VCCI1 needs to not only minimize the magnitude of a peak current during the power-up operation period, but also stably maintain a target voltage during the normal operation period following the power-up operation period, Furthermore, the first internal voltage VCCI1 may have a relatively high target voltage. For example, the first internal voltage VCCI1 may include a core voltage of a semiconductor memory device.

On the other hand, although the second internal voltage VCCI2 needs to minimize the magnitude of the peak current during the power-up operation period, the second internal voltage VCCI2 may be close to the target voltage while maintaining positive during the normal operation period following the power-up operation period. Furthermore, the first internal voltage VCCI1 may have a relatively low target voltage. For example, the first internal voltage VCCI1 may include a back bias voltage of a semiconductor memory device or, in particular, a back bias voltage for preventing a latch-up in a column decoding circuit.

As such, when the first and second internal voltages VCCI1 and VCCI2 are generated in different manners because the first and second internal voltages VCCI1 and VCCI2 are used for different purposes, the magnitude of the peak current may be effectively minimized during the power-up operation period, That is, the first internal voltage VCCI1 needs to be provided to the semiconductor device, while the first internal voltage VCCI1 does not have a rapidly increasing curve according to an increase in the external voltage VCCE but has a voltage which stably increases without a large fluctuation during the power-up operation period. Thus, the first internal voltage generation unit 540 may drive the first internal voltage (VCCI1) terminal with the first drivability which is relatively large. Furthermore, since the first internal voltage (VCCI1) terminal needs to stably maintain the target voltage even during the normal operation period after the power-up operation period, the third internal voltage generation unit 500 may control the first internal voltage (VCCI1) terminal to maintain the target voltage at all times.

On the other hand, as long as the second internal voltage VCCI2 may be controlled not to have a rapidly increasing curve according to the increase in the external voltage VCCE, the second internal voltage VCCI2 may be provided to the semiconductor device, while the second internal voltage VCCI2 is positive. Thus, the second internal voltage generation unit 580 may drive the second internal voltage (VCCI2) terminal with the second drivability which is relatively small. Furthermore, since the second internal voltage VCCI2 maintains only a positive voltage even during the normal operation period after the power-up operation period, the second internal voltage generation unit 580 may be controlled to continuously operate.

When the embodiment of the present invention is applied as described above, the damping circuit may be used to determine the internal voltage corresponding to the external voltage during the power-up operation period. Thus, the current consumption may be gradually increased as the external voltage increases. Thus, the magnitude of the peak current may be minimized during the power-up operation.

Although various embodiments have been described for illustrative purposes, it will be apparent to those skilled in the art that various changes and modifications may be made without departing from the spirit and scope of the invention as defined in the following claims.

For example, the positions and types of the logic gates and transistors used in the above-described embodiments may be changed depending on the polarities of the input signals.

1. A semiconductor device comprising:
a first reference voltage generation unit suitable for outputting an external voltage as a first reference voltage and clamping the first reference voltage based on a preset voltage in a positive direction from a ground voltage;
a first internal voltage generation unit suitable for receiving the external voltage to drive an internal voltage terminal with a drivability corresponding to the first reference voltage; and
a second internal voltage generation unit suitable for receiving the external voltage to drive the internal voltage terminal based on a second reference voltage that is greater than the preset voltage.

2. The semiconductor device of claim 1, wherein the first reference voltage generation unit outputs the first reference voltage having the same voltage as the external voltage during a period in which the external voltage is less than or equal to a voltage shifted by the preset voltage in the positive direction from the ground voltage, and clamps the first reference voltage to the voltage shifted by the preset voltage in the positive direction from the ground voltage during a period in which the external voltage is greater than the voltage shifted by the preset voltage in the positive direction from the ground voltage.

3. The semiconductor device of claim 1, wherein the second internal voltage generation unit couples an external voltage terminal to the internal voltage terminal during a period in which an internal voltage is less than or equal to the second reference voltage, and separates the external voltage terminal from the internal voltage terminal during a period in which the internal voltage is greater than the second reference voltage, after a power-up operation period.

4. The semiconductor device of claim 1, wherein the first reference voltage generation unit comprises a depletion-type NMOS transistor suitable for fixing a gate terminal to the ground voltage when a threshold voltage is shifted by the preset voltage in a negative direction from the ground voltage, and adjusting the first reference voltage coupled to a source terminal in response to variation of the external voltage coupled to a drain terminal.

5. The semiconductor device of claim 1, wherein the first internal voltage generation unit comprises an NMOS transistor suitable for adjusting a current flowing between an external voltage terminal coupled to a drain terminal and the internal voltage terminal coupled to a source terminal in response to the first reference voltage applied to a gate terminal.

6. The semiconductor device of claim 1, wherein the second internal voltage generation unit comprises:
a comparison unit suitable for generating a control signal whose activation is determined in response to a comparison result between an internal voltage and the second reference voltage and an enable signal activated after a power-up operation period; and
a coupling control unit suitable for coupling an external voltage terminal to the internal voltage terminal during an active period of the control signal, and separating the external voltage terminal from the internal voltage terminal during an inactive period of the control signal.

7. The semiconductor device of claim 1, further comprising:
a first sinking unit coupled between a first reference voltage terminal and a ground voltage terminal to sink a leakage current from the first reference voltage terminal to the ground voltage terminal; and
a second sinking unit coupled between the internal voltage terminal and an external voltage terminal to sink a current from the internal voltage terminal to the external voltage terminal when an internal voltage is greater than the external voltage.

8. The semiconductor device of claim 1, wherein when the external voltage is less than or equal to a voltage shifted by the preset voltage in the positive direction from the ground voltage regardless of entering a power-up operation period, the first reference voltage generation unit and the first internal voltage generation unit operate to vary the first reference voltage in response to variation of the external voltage, and drive the internal voltage terminal with a drivability which varies in response to the varied voltage of the first reference voltage,
when the external voltage is greater than the voltage shifted by the preset voltage in the positive direction from the ground voltage, regardless of entering the power-up operation period, the first reference voltage generation unit and the first internal voltage generation unit fix the first reference voltage to the preset voltage regardless of the variation of the external voltage, and drive the internal voltage terminal with a drivability which is fixed in response to the fixed voltage of the first reference voltage, and
the second internal voltage generation unit does not drive the internal voltage terminal regardless of variation of an internal voltage during the power-up operation period, and selectively drives the internal voltage terminal in response to the variation of the internal voltage after exiting from the power-up operation period.

9. A semiconductor device comprising:
a first reference voltage generation unit suitable for outputting an external voltage as a first reference voltage, and clamping the first reference voltage based on a first voltage in a positive direction from a ground voltage;
a second reference voltage generation suitable for outputting the external voltage as a second reference voltage, and clamping the second reference voltage based on a second voltage in the positive direction from the ground voltage, the second voltage being less than the first voltage;
a first internal voltage generation unit suitable for receiving the external voltage to drive a first internal voltage terminal with a first drivability corresponding to the first reference voltage;
a second internal voltage generation unit suitable for receiving the external voltage to drive a second internal voltage terminal with a second drivability corresponding to the second reference voltage, the second drivability being smaller than the first drivability; and
a third internal voltage generation unit suitable for receiving the external voltage to drive the first internal voltage terminal based on a third reference voltage greater than the first voltage in the positive direction from the ground voltage.

10. The semiconductor device of claim 9, wherein the first reference voltage generation unit outputs the first reference voltage having the same voltage as the external voltage during a period in which the external voltage is less than or equal to a voltage shifted by the first voltage in the positive direction from the ground voltage, and clamps the first reference voltage to the voltage shifted by the first voltage in the positive direction from the ground voltage during a period in which the external voltage is greater than the voltage shifted by the first voltage in the positive direction from the ground voltage.

11. The semiconductor device of claim 9, wherein the second reference voltage generation unit outputs the second reference voltage having the same voltage as the external voltage during a period in which the external voltage is less than or equal to a voltage shifted by the second voltage in the positive direction from the ground voltage, and clamps the second reference voltage to the voltage shifted by the second voltage in the positive direction from the ground voltage during a period in which the external voltage is greater than the voltage shifted by the second voltage in the positive direction from the ground voltage.

12. The semiconductor device of claim 9, wherein the third internal voltage generation unit couples an external voltage terminal to the first internal voltage terminal during a period in which an internal voltage is less than or equal to the third reference voltage, and separates the external voltage terminal from the first internal voltage terminal during a period in which the internal voltage is greater than the third reference voltage, after a power-up operation period.

13. The semiconductor device of claim 9, wherein the first reference voltage generation unit comprises a first depletion-type NMOS transistor suitable for fixing a gate terminal to the ground voltage when a threshold voltage is shifted by the first voltage in a negative direction from the ground voltage, and adjusting the first reference voltage coupled to a source terminal in response to variation of the external voltage coupled to a drain terminal.

14. The semiconductor device of claim 9, wherein the first internal voltage generation unit comprises a first NMOS transistor suitable for adjusting a current flowing between an external voltage terminal coupled to a drain terminal and the first internal voltage terminal coupled to a source terminal in response to the first reference voltage applied to a gate terminal.

15. The semiconductor device of claim 9, wherein the second reference voltage generation unit comprises a second depletion-type NMOS transistor suitable for fixing a gate terminal to the ground voltage when a threshold voltage is shifted by the second voltage in a negative direction from the ground voltage, and adjusting the second reference voltage coupled to a source terminal in response to variation of the external voltage coupled to a drain terminal.

16. The semiconductor device of claim 9, wherein the second internal voltage generation unit comprises a second NMOS transistor suitable for adjusting a current flowing between an external voltage terminal coupled to a drain terminal and the second internal voltage terminal coupled to a source terminal in response to the second reference voltage applied to a gate terminal.

17. The semiconductor device of claim 9, wherein the third internal voltage generation unit comprises:
a comparison unit suitable for generating a control signal whose activation is determined in response to a comparison result between an internal voltage and the third reference voltage and an enable signal which is activated after a power-up operation period; and
a coupling control unit suitable for coupling an external voltage terminal to the first internal voltage terminal during an active period of the control signal, and separating the external voltage terminal from the first internal voltage terminal during an inactive period of the control signal.

18. The semiconductor device of claim 9, further comprising:
a first sinking unit coupled between a first reference voltage terminal and a ground voltage terminal to sink a leakage current from the first reference voltage terminal to the ground voltage terminal;
a second sinking unit coupled between a second reference voltage terminal and the ground voltage terminal to sink a leakage current from the second reference voltage terminal to the ground voltage terminal;
a third sinking unit coupled between the first internal voltage terminal and an external voltage terminal to sink a current from the first internal voltage terminal to the external voltage terminal when a first internal voltage is greater than the external voltage; and
a fourth sinking unit coupled between the second internal voltage terminal and the external voltage terminal to sink a current from the second internal voltage terminal to the external voltage terminal when a second internal voltage is greater than the external voltage.

19. The semiconductor device of claim 9, wherein when the external voltage is less than or equal to a voltage shifted by the first voltage in the positive direction from the ground voltage regardless of entering a power-up operation period, the first reference voltage generation unit and the first internal voltage generation unit operate to vary the first reference voltage in response to variation of the external voltage, and drive the first internal voltage terminal with the first drivability which varies in response to the varied voltage of the first reference voltage,
when the external voltage is greater than the voltage shifted by the first voltage in the positive direction from the ground voltage regardless of entering the power-up operation period, the first reference voltage generation unit and the first internal voltage generation unit operate to fix the first reference voltage to the first voltage regardless of the variation of the external voltage, and drive the first internal voltage terminal with the first drivability which is fixed in response to the fixed voltage of the first reference voltage, and
the third internal voltage generation unit does not drive the first internal voltage terminal regardless of variation of a first internal voltage during the power-up operation period, and selectively drives the first internal voltage terminal in response to the variation of the first internal voltage after exiting from the power-up operation period.

20. The semiconductor device of claim 9, wherein when the external voltage is less than or equal to a voltage shifted by the second voltage in the positive direction from the ground voltage regardless of entering a power-up operation period, the second reference voltage generation unit and the second internal voltage generation unit operate to vary the second reference voltage in response to a voltage variation of the external voltage, and drive the second internal voltage terminal with the second drivability which varies in response to the varied voltage of the second reference voltage, and
when the external voltage is greater than the voltage shifted by the second voltage in the positive direction from the ground voltage regardless of entering the power-up operation period, the second reference voltage generation unit and the second internal voltage generation unit operate to fix the second reference voltage to the second voltage regardless of the variation of the external voltage, and drive the second internal voltage terminal with the second drivability which is fixed in response to the fixed voltage of the second reference voltage.
